(19) United States
(12) Patent Application Publication
(10) Pub. No.: US 2018/0139942 A1
(43) Pub. Date: May 24, 2018

(54) POWERED BAIT DEVICE AND METHODS OF USE THEREOF

(71) Applicant: Magurobotics LLC, Boston, MA (US)

(72) Inventors: Newbold R. Varian, Phippsburg, ME (US); Matthew F. Borowski, Somerville, MA (US); Jessy Cusack, Attleboro, MA (US)

(73) Assignee: Magurobotics LLC, Boston, MA (US)

(21) Appl. No.: 15/568,570

(22) PCT Filed: May 13, 2016
(86) PCT No.: PCT/US16/32358

§ 371 Date: Oct. 23, 2017

Related U.S. Application Data
(60) Provisional application No. 62/179,688, filed on May 15, 2015.

(51) Int. Cl. A01K 85/01

(52) U.S. Cl. CPC A01K 85/01; A01K 99/00

(57) ABSTRACT

Provided herein are embodiments of a motion-generating apparatus capable of inducing tail deflection in a fish suitable for use as fishing bait when introduced therein. The device may be capable of being inserted into any number of fishing bait decoys either artificial or natural. The device may be fully self-contained such that it does not include external wires or tethers. The device may also be actuated when placed in water.

### RELATED APPLICATIONS

This application is a National Stage filing under 35 U.S.C. § 371 of International Application No. PCT/US2016/032358, filed May 13, 2016, which claims the benefit of priority of U.S. Provisional Application No. 62/179,688, filed May 15, 2015, each of which is hereby incorporated by reference in its entirety.

### FIELD

Disclosed embodiments are related to powered bait devices and methods of use thereof.

### BACKGROUND

In both recreational and commercial fishing, bait that is capable of movement is preferred over passive, nonmoving bait. This can be seen in the use of lures which, when dragged in the water, create a splashing or disturbance to the surrounding water. Predatory fish such as swordfish, king mackerel, and tuna are recreationally and commercially fished using pole-and-line methods. The use of live bait, while capable of volitional movement, presents a problem to fisherman due to supply and demand fluctuations that limit the availability of bait fish or dramatically increase their price. Additionally there are substantial requirements of time, space, and money associated with the keeping of the live bait fish, on a fishing vessel or otherwise. Live bait fish generally require special, large tanks to properly oxygenate the water to keep the fish alive. Furthermore, once a bait fish is dead, it is incapable of producing movement and is less attractive of predatory fish. If live bait is unavailable, a user has the option using dead bait, known as chunk bait, or an inorganic lure, such as a lure that mimics the overall look and shape of a bait fish, but is not perceived as a bait fish by predatory fish.

### SUMMARY

In one embodiment, a motion-generating apparatus includes a drive operably connected to a deflectable structure that is constructed and arranged to be inserted into a mouth of a bait fish. The drive and deflectable structure is capable of causing a deflection of a portion of the bait fish of at least 5 degrees.

In another embodiment, a device includes a housing, a movable portion, and a drive that moves the movable portion relative to the housing. The housing, movable portion, and drive are sized and shaped to fit at least partially within a bait fish. Further, the drive and movable portion when positioned in the bait fish move a first portion of the bait fish relative to a second portion of the bait fish.

In yet another embodiment, a method includes: inserting a device including a housing and a movable portion at least partially inside a bait; and moving the movable portion relative to the housing to move a first portion of the bait relative to a second portion of the bait.

It should be appreciated that the foregoing concepts, and additional concepts discussed below, may be arranged in any suitable combination, as the present disclosure is not limited in this respect. Further, other advantages and novel features of the present disclosure will become apparent from the following detailed description of various non-limiting embodiments when considered in conjunction with the accompanying figures.

### BRIEF DESCRIPTION OF THE DRAWINGS

The accompanying drawings illustrate various embodiments of the present system and method and are a part of the specification. The accompanying drawings are not intended to be drawn to scale. In the drawings, each identical or nearly identical component that is illustrated in various figures may be represented by a like numeral. For purposes of clarity, not every component may be labeled in every drawing. Additionally, it should be understood that the illustrated embodiments are merely examples of the present system and method and do not limit the scope thereof. In the drawings:

FIG. 1(a) is an external perspective view of one embodiment of an assembled bait device that uses a ball and yoke arrangement to produce the desired motion;

FIG. 1(b) is an exploded view of the device of FIG. 1(a);

FIG. 1(c) is a sectioned view illustrating the oscillation mechanism of the device of FIG. 1(a);

FIG. 2(a) is an external perspective view of one embodiment of an assembled bait device that uses a pin and yoke arrangement to produce the desired motion;

FIG. 2(b) is an exploded view of the device of FIG. 2(a);

FIG. 2(c) is a sectioned view illustrating the oscillation mechanism of the device of FIG. 2(a);

FIG. 3(a) is an external perspective view of one embodiment of an assembled bait device that uses replaceable batteries;

FIG. 3(b) is an exploded view of the device of FIG. 3(a);

FIG. 4(a) is an external perspective view of one embodiment of an assembled bait device; and

FIG. 4(b) is an exploded view of the device of FIG. 4(a); and

FIG. 4(c) is a sectioned view illustrating the oscillation mechanism of the device of FIG. 4(a).

FIG. 5 is a depiction of an embodiment and a device including a chemical attractant.

### DETAILED DESCRIPTION

In view of dead bait not being as effective as live bait, the Inventors have recognized that there is a need in for bait devices that allow dead fish to more closely mimic live fish. For example, a bait device may induce movement in a dead and/or synthetic bait that is otherwise incapable of volitional movement. Thus, in some embodiments, a device may be affixed to or inserted into a dead bait fish, or synthetic bait, that is capable of producing motion in the bait. By producing the desired underwater swimming motion, a user may increase the attractiveness of the bait to valuable, predatory fish such as tuna, king mackerel, sailfish, pompano, spanish mackerel, bonito, barracuda, bluefish, red drum, false albacore, snook, grouper, shark, marlin, barramundi, roosterfish, cobia, seabass, striped bass, snapper, pike, muskie, walleye, trevally, salmon, pickerel, wahoo, tarpon, mahi mahi, porgies, spearfish, swordfish, and the like, and thus increase the strike rate for the user.

It should be understood that a device may impart any type of motion into a bait. However, in some embodiments, it may be desirable that the imparted movement be similar to the volitional movement of a live bait fish. Appropriate movements that may be mimicked include any type of movement that is desirable to a predatory fish, including repeatedly inducing an angle between the head and tail portion of the bait, a wave-like oscillation throughout the body of the bait, random or erratic motion of the body similar to that of an injured animal, motion of only an appendage or portion of the bait, or other types of motion that mimic the desirable action of a bait. This motion may be applied to the full body of the bait or only a portion or appendage of the bait as the disclosure is not so limited.

While motion may be induced in bait using any appropriate combination of features, in one embodiment, a device is sized to fit within and/or attached to a desired type of bait. The device may be a deflectable structure that includes a housing and a movable portion extending from the housing. A deflectable structure is a mechanical form which contains one or more features which allows movement of one section of the manifold in relation to any other section creating an angle greater than 0 degrees in the manifold. The movable portion may correspond to any appropriately shaped structure capable of moving a portion of a bait the movable portion is positioned in relative to a portion of the bait the housing is positioned in. Appropriate structures include, but are not limited to shafts, tubes, blades, paddles, needles, pins, as well as elongated blocks to name a few. The movable portion may be moved in any appropriate type of motion relative to the housing including for example, reciprocating motion along an arc, reciprocating linear motion along an axis, angled rotation about a central axis such that movement of the movable portion defines a frustoconical shape, as well as any other motion that may be used to attract a predatory fish.

In order to produce the desired motion between a housing and movable portion of a device to produce motion in bait, a device may include any number of appropriate drives. A drive is a device which converts stored energy into a mechanical force or torque to be delivered by an actuator exerted over the period of time for which there is energy applied. A drive may produce, for example, continuous or intermittent rotary motion to drive a mechanical linkage or eccentric appendage, linear motion such as that provided by a piston or cable, electromotive force from an electromagnet to induce motion in an attracted or repelled magnetic component, deformation of a flexible component due to induced pressure or electrical excitation, direct bio-electric stimulation of the bait tissue if used with once-living bait, or any other means of creating motion. In view of the above, a drive may include one or more of an electric motor, electroactive polymers, piezoelectric materials, a hydraulic motor, transmission gears, cables, pistons, electromagnetic coils, magnetic materials, springs, eccentrically rotated pins, slots, yokes, and/or combinations of the above. For example, in one embodiment described further below, a drive may include an electric motor coupled with an eccentric pin or ball that is rotated about an axis to drive a yoke or slot it is associated with in a reciprocating motion. Therefore, it should be understood that any number of different types of drives may be used to drive the motion between the housing and movable portion of a device as the disclosure is not so limited.

To provide energy for the above noted drive, a device may incorporate any number of different types of appropriate power sources. Depending on the particular type of drive being used, a power source may be a battery, capacitor, mechanical winding, kinetic energy storage device, heat source, chemical reaction, hydraulic or pneumatic accumulator, or any other storage means which may provide energy to the device. Further, depending on the particular type of use, a power source may be rechargeable, replaceable, or it may be one-time use. Alternatively, power may be externally supplied to a device via wireless transmission or a physical connection allowing electricity, pneumatic or hydraulic fluid, mechanical displacement via a cable or wire, or any other means of providing energy to the drive.

The device may be turned on and off via a user-operated switch or button, via sensing characteristics of the environment such as pressure, presence of water, light levels, etc., or remotely via a signal from a wired or wireless connection. A button may be used to control the device which may be a pushbutton, a rocker switch, a toggle switch, a slider switch, a tactile button, a rotary knob, or any other kind of electromechanical switching mechanism. Additionally, a pressure transducer could trigger the device using the deflection of a given material when under the force of pressure from being submerged in water. A photocell could be used to turn light into a voltage for turning the device on or off. A water sensing circuit which detects changes in the bias to one or more transistors could be used to detect the submergence of the device in a liquid. A near field or RF connection could be established to the electronics in the device such that the device can be turned on from a distance while the device is located inside or outside of a bait fish. Any of these control apparatuses listed above may be used as standalone turn on/turn off switches or used in any combination to control the device.

In some embodiments, a device may also include one or more features to facilitate its reuse. For example, in addition to a rechargeable power source, a device may also incorporate features for retrieval, such as a hook attached to, or integrally formed with, either the housing or movable portion of the device. Alternatively, a features such as a clamp, eye hole, or other appropriate feature may be used to attach an otherwise separate hook and line to the device. In instances where a hook is somehow associated with the device, a fishing line may be attached to the hook to effect retrieval of both the hook and device. Alternatively, in some embodiments, —a fishing line, or a tether separate from the fishing line, may be attached directly to the device.

In some applications, it may be desirable to further improve the retrieval of a device. In one such embodiment, a device may include an automated homing functionality using the motion of the device or other means of return to a point of origin or easy retrieval, or other features which facilitate the retrieval of the device after deployment. The device may contain a compressed gas cylinder which could empty into an inflatable structure allowing the device to float safely to the top of the water to be retrieved. It may also be desirable for the device to propel itself through water guided using electronics towards an acoustical beacon located near the device's user to aid retrieval of the device.

For reuse and general robustness of the device, it may be beneficial to include certain features to improve the resistance of the device to expected environmental conditions encountered in use. Protective features may be used to insulate components of the device that may be sensitive to conditions encountered in corrosive and high-pressure in-use environments. Such features may be protective coatings, seals, and adhesives used in conjunction with a housing enclosure to prevent ingress of water into an internal cavity of the device's housing. In another embodiment, a soft flexible membrane that encapsulates a portion, or all of, a device while still permitting motion may be used. Of course, it should be understood that any other means of preventing exposure of sensitive components to the surrounding environment may be used. In addition, to the sealing features noted above, structural elements as well as component fixation of the device may be constructed with adequate integrity to withstand in-use pressure as well as shock resulting from interaction with sea life and handling in a sport, leisure, and/or commercial fishing environment.

As used herein, the terms “bait” and “bait material”, or other similar phrases, refer to all materials, either biological or artificial in which a bait device may be disposed within and whose features are to be moved by actuation of the device.

In one embodiment of a device, the swimming motion of a fish is simulated by inducing an angle between the head and tail portion of a bait, alternating back and forth. The pivot point produced by a device associated with the bait may be located between the head and tail, and is determined by the relative lengths of the housing and movable portions of the device. The ratio of housing length to movable portion length may be between 10:1 and 1:1, 5:1 and 1:1, 3:1 and 1:1, 2:1 and 1:1, 1:10 and 1:1, 1:5 and 1:1, 1:3 and 1:1, 1:2 and 1:1, 10:1 and 1:10, 5:1 and 1:5, 3:1 and 1:3, and 2:1 and 1:2.

A device may also produce movement with a sufficient amplitude to cause perceptible movement of the different portions of a bait. For example, angular movement may be imparted to the head and tail of a bait with a sufficient range of angular movement such that at least a portion of the tail moves relative to the head, in a manner of motion similar to that of a live bait fish. In one such embodiment, an angular amplitude of the motion between a housing and movable portion of a device may be at least about 5 degrees, 10 degrees, 15 degrees, 20 degrees, 25 degrees, 30 degrees, 35 degrees, 40 degrees, 45 degrees, or any other appropriate angle to either side of a neutral position. The range of angular motion may also be less than about 60 degrees, 45 degrees, 30 degrees, or any other appropriate angle to either side of a neutral position. Combinations of these ranges of angles are contemplated, including, for example a range of motion between about 5 degrees and 60 degrees on either side of a neutral position.

In some embodiments, the motion of a device may also occur either at a fixed or variable frequency of oscillation for movement of a movable portion of a device relative to a housing of the device. In some instances, the mode of operation is preset for the device, though embodiments in which a user may set a fixed or variable frequency of oscillation of the device are also contemplated. In certain embodiments the frequency is greater than about 0.1 Hz, 0.5 Hz, 1 Hz, 2 Hz, 3 Hz, 4 Hz, 5 Hz, 6 Hz, 7 Hz, 8 Hz, 9 Hz, or any other appropriate frequency. Similarly, the frequency may be less than about 10 Hz, 9 Hz, 8 Hz, 7 Hz, 6 Hz, 5 Hz, 4 Hz, 3 Hz, 2 Hz, 1 Hz, 0.5 Hz, or any other appropriate frequency. Combinations of the above frequency ranges are contemplated, including, for example, frequencies between or equal to about 0.1 Hz and 10 Hz as well as 0.5 to 1.0 Hz, 0.5 to 1.5 Hz, 0.5 to 2.0 Hz, 0.5 to 2.5 Hz, 0.5 to 3.0 Hz, 1.0 Hz to 2.0 Hz, 1.0 Hz, to 2.5 Hz, 1.0 Hz to 3.5 Hz, 1.5 Hz to 2.0 Hz, 1.5 Hz to 2.5 Hz, 1.5 Hz to 3.0 Hz, 1.5 Hz to 3.5 Hz, 2.0 Hz to 3.0 Hz, 2.0 Hz to 3.5 Hz, 2.5 Hz to 3.5 Hz, 2.5 Hz to 4.0 Hz, 3.0 Hz to 4.0 Hz, 3.5 Hz to 4.5 Hz, 4.0 Hz to 5.0 Hz, 5.0 Hz to 6.0 Hz, 6.0 Hz to 8.0 Hz, 8.0 Hz to 10.0 Hz, 10.0 Hz to 15.0 Hz. Of course embodiments, in which frequencies both less than and greater than those noted above are also contemplated as the current disclosure is not so limited. In instances where a variable frequency is used, a user may select a desired frequency within a range of operation frequencies to operate the device to mimic the movement of the tail relative to the body of a different bait fish in the water with a desired type of movement.

In one embodiment of the device, the motion is continuous for at least about 1 second, such as 2, 5, 10, 15, 20, 25, 30, 35, 40, 45, 50, 55 seconds, or greater than 1 minute, such as 2, 5, 10, 15, 30, 60 minutes or 1, 2, 3, 4, 5, 6, 7, 8, 9, 10 or greater than 10 hours. Combinations of the above continuous movement ranges are contemplated, including, for example, times between 0.5 and 2.0 seconds, 1 to 3 seconds, 1 to 5 seconds, 1 to 10 seconds, 2 to 10 seconds, 2 to 15 seconds, 5 to 15 seconds, 5 to 20 seconds, 5 to 30 seconds, 10 to 30 seconds, 10 to 45 seconds, 20 to 30 seconds, 20 to 45 seconds, 20 to 60 seconds, 30 to 45 seconds, 30 to 60 seconds, 30 seconds to 2 minutes, 45 seconds to 2 minutes, 45 seconds to 5 minutes, 1 minute to 2 minutes, 1 minute to 5 minutes, 1 minute to 10 minutes, 5 minutes to 10 minutes, 5 minutes to 20 minutes, 5 minutes to 30 minutes, 10 minutes to 20 minutes, 10 minutes to 30 minutes, 10 minutes to 1 hour, 20 minutes to 1 hour, 20 minutes to 2 hours, 30 minutes to 1 hour, 30 minutes to 2 hours, 30 minutes to 3 hours, 1 hour to 2 hours, 1 hour to 2.5 hours, 1 hour to 3 hours, 1 hour to 3.5 hours, 1 hour to 5 hours, 2 hours to 3 hours, 2 hours to 4 hours, 2 hours to 5 hours, 2 hours to 10 hours, 3 hours to 4 hours, 3 hours to 5 hours, 3 hours to 10 hours, or 4 hours to 10 hours.

A device may be capable of generating movement for short durations followed by a pause in movement and repeated in pseudorandom intervals which would mimic the movement of a bait fish which has been injured. This type of on-off-on movement may be attractive to predatory fish during certain seasons and feeding cycles and to specific types of fish and thus would be valuable to the user. This interval, or duty cycle, would lead to an improvement in run time as there would not be any stored energy used during the pause in movement. In another embodiment of the device, the motion alternates between periods of motion and inactivity by a user defined duty cycle of greater than 10%, or greater than 20%, 30%, 40%, 50%, 60%, 70%, 80% or 90%. In one embodiment this duty cycle is of fixed duration however in another embodiment this duty cycle is of a random or irregular duration. Combinations of the above duty cycle ranges are contemplated, including, for example, duty cycles between 0% and 10%, 5% and 15%, 5% and 20%, 10% and 15%, 10% and 20%, 10% and 25%, 15% and 20%, 15% and 25%, 15% and 30%, 15% and 35%, 20% and 30%, 20% and 40%, 25% and 35%, 25% and 55%, 25% and 65%, 30% and 40%, 30% and 50%, 30% and 60%, 30% and 70%, 40% and 50%, 40% and 60%, 40% and 70%, 50% and 60%, 50% and 75%, 50% and 85%, 50% and 100%, 60% and 80%, 60% and 100%, 70% and 80%, 70% and 90%, 70% and 100%, 80% and 90%, 80% and 100%, or 90% and 100%.

As noted previously, a device may be inserted either partially, or fully, inside a bait. While this may be accomplished in a variety of ways, in one embodiment, an incision is made in the body of the bait and the device is inserted into the incision. Depending on the embodiment, the device may either anchor itself within the incision, or the incision may be closed using sutures, pins, or other similar methods. In order to be fully contained within a typical bait fish, the device dimensions should be about or less than 250 mm in length, 50 mm in width, and 50 mm in height. This allows for insertion into the mouth of a normal bait fish, e.g, a herring or a mackerel, which are commonly used to catch tuna. Generally bait fish such as herring, mackerel, etc have lengths of less than about 470 mm, but one of skill in the art will recognize that these lengths vary. Other bait within which the device can be contained might be blue runners, whiting, scad, ballyhoo, aku, goggle eyes, pinfish, anchovies, sea breams, gobies, perch, shiners, chubs, smelts, suckers, menhaden, sardines, shads, pilchards, mullet, eels, squid, worms or any other freshwater or saltwater species used as bait. To accommodate use with the variety of sizes of bait fish available, the total length of the device may be between 10 mm and 350 mm, 10 mm and 300 mm, 10 mm and 250 mm, 10 mm and 200 mm, 10 mm and 150 mm, 10 mm and 120 mm, 10 mm and 90 mm, 10 mm and 60 mm, 10 mm and 30 mm, 30 mm and 350 mm, 60 mm and 350 mm, 90 mm and 350 mm, 90 mm and 350 mm, 120 mm and 350 mm, 150 mm and 350 mm, 200 mm and 350 mm, 250 mm and 350 mm, and 300 mm and 350 mm.

In another embodiment, the device is inserted substantially or fully inside the bait through the oral cavity. The width and height dimensions, defined as the dimensions orthogonal to the length dimension, determine the size of the oral cavity through which the device may be inserted. To accommodate use with the variety of sizes of bait fish available, width and height, may both be between 1 mm and 50 mm, 1 mm and 40 mm, 1 mm and 30 mm, 1 mm and 25 mm, 1 mm and 20 mm, 1 mm and 15 mm, 5 mm and 50 mm, 10 mm and 50 mm, and 15 mm and 50 mm.

Of course, while particular dimensions have been given above for a device, it should be understood that a device may be sized and shaped for use with any size bait both larger and smaller than those noted above as the disclosure is not so limited.

To accommodate bait fish of a variety of sizes, in some embodiments, a device may include an adjustable length moveable portion or a replaceable moveable portion. Thus, in such an embodiment, a user may be able to alter the moveable portion's length, width, and height to ensure proper fitment within a bait fish or other type of bait. For example, in one embodiment a movable portion or housing may have an extension that is telescoping or threaded to allow the user to adjust overall device size. In another embodiment, the movable portion or housing has interchangeable versions of different size, which can be exchanged by the user via removable fasteners to modify the overall size of the device. In this way the total device size, as well as ratio of housing to movable portion sizes, may be adjusted to best suit the bait in use.

While a power source of a device may be any appropriate component, in one embodiment a power source is comprised of one or a plurality of electrochemical cells located substantially or entirely within the device's housing. In such an embodiment, the housing may optionally correspond to a waterproof enclosure. Appropriate electrochemical cells include, but are not limited to, lithium-ion, lithium metal, nickel metal hydride, alkaline, silver oxide, or any other appropriate cell chemistry. Depending on the embodiment, it may be desirable to provide a DC voltage between about 3 volts and 6 volts, though other voltages are also possible. In such an embodiment, one lithium-ion cell, two alkaline cells in series, four alkaline cells in series, or any other appropriate number and combination of electrochemical cells may be used. Depending on the size and number of electrochemical cells used, the electrochemical cells may have a combined capacity of greater than about 100 mAh, such as greater than 200, 300, 400, 500, 600, 700, 800, 900 mAh or greater than 1, 2, 3, 4, or 5 Ah. Combinations of the above current capacity are contemplated, including, for example, current capacity between 50 mAh and 200 mAh, 50 mAh and 300 mAh, 100 mAh and 200 mAh, 100 mAh and 300 mAh, 100 mAh and 400 mAh, 200 mAh and 400 mAh, 200 mAh and 500 mAh, 200 mAh and 600 mAh, 300 mAh and 500 mAh, 300 mAh and 600 mAh, 300 mAh and 700 mAh, 300 mAh and 800 mAh, 400 mAh and 500 mAh, 400 mAh and 600 mAh, 400 mAh and 700 mAh, 400 mAh and 800 mAh, 500 mAh and 700 mAh, 500 mAh and 800 mAh, 500 mAh and 800 mAh, 500 mAh and 900 mAh, 500 mAh and 1000 mAh, 600 mAh and 800 mAh, 600 mAh and 1000 mAh, 600 mAh and 1200 mAh, 700 mAh and 1000 mAh, 700 mAh and 1200 mAh, 700 mAh and 1400 mAh, 800 mAh and 1000 mAh, 800 mAh and 1200 mAh, 800 mAh and 1400 mAh, 1000 mAh and 1200 mAh, 1000 mAh and 1400 mAh, 1000 mAh and 1600 mAh, 1000 mAh and 1800 mAH, 1200 mAh and 1500 mAh, 1200 mAh and 2000 mAh, 1400 mAh and 1800 mAh, 1600 mAh and 2000 mAh, 1600 mAh and 2500 mAh, or 1800 mAh to 3000 mAh. Electrochemical cells with an appropriate power rating for delivering a desired amount of torque to move the tail portion of a bait fish using an associated drive may be used. Depending on the application, it may be desirable to reuse a device. Therefore, in some embodiments, the electrochemical cells of a device are capable of being recharged and reused for the entire life of the device. However, embodiments in which the electrochemical cells are replaceable, or the device is a one time use device, are also contemplated as the disclosure is not so limited. Appropriate power transformers may be used to supply a desired combination of voltage and current to a motor of a device. For example, in one embodiment, a power supply and power smoothing filter generate a stepped-up DC voltage of approximately 12 volts with a current source of greater than 50 mA, for a total supplied power of 600 mW to greater than 6 W The power supply and related control circuitry is capable of supplying continuous or intermittent power to the gearmotor based on user input. This power supply also contains an embedded means of sensing voltage, which is a measure of total charge available to the device. In one embodiment, the device may contain a means of displaying total available charge, such as via a combination of light emitting diodes that are visible to a user. For example, a series of lights may be illuminated when a user presses a button indicating full charge, and the number of lights is reduced with decreasing charge. In another embodiment, the device may wirelessly transmit battery charge information to the user, such as via a wired control tether or via a wireless communication signal that is then displayed on an associated display as might be present on a dock, controller, linked smart phone or tablet, linked computer, or other device including a display.

As discussed previously, in some embodiments, an electric motor, such as an electromagnetic gearmotor, may be used to convert electric power into mechanical power in a device. The motor is powered via a DC power source and is small enough to be disposed substantially, or entirely, inside of the device's housing, which may optionally be a waterproof enclosure. Within such a motor, there may be a gearbox including one or more gears operably connected to the motor. The gears may be metal or plastic gears. In one embodiment, this gearbox includes of an inline output shaft that outputs motion to the other portions of the device's drive. However, in another embodiment, the gearbox may have an approximately 90 degree output shaft. Depending on the embodiment, the gearbox may have a gear ratio of greater than 2:1, such as greater than 4:1, 8:1, 16:1, 32:1, 64:1, 128:1, 256:1, 512:1, and 1028:1 or greater in order to supply adequate torque to provide the desired motion to a bait fish. Combinations of the above current gear ratios are contemplated, including, for example, gear ratios between 2:1 and 4:1, 3:1 and 8:1, 7:1 and 16:1, 15:1 and 32:1, 31:1 and 64:1, 63:1 and 128:1, 127:1 and 256:1, 255:1 and 512:1, or 511:1 and 1028:1.

Depending on the embodiment, a motor may be coupled to a rigid movable portion through a dynamic, rotational linkage comprised of metal or plastic components. In one such embodiment, the rotational power of the motor is translated to an elongated movable portion which then transfers the motion to the tail end of a bait fish, however this motion could also be used move the head end as well.

In certain embodiments, a device and all electronics may be actuated through sensing its presence in a preferred environment, such as submersion in water. There are one or a plurality of sensors capable of electronically signaling the device's current environment and are impervious to the effects of corrosive environments. The sensors are of relatively small size and weight but are designed to prevent inadvertent actuation when the device is not located around or in water. In one embodiment, one or more electrodes are located outside of a waterproof enclosure that provide feedback to the controller, when submerged in water, supplies power to the motor. One or more electrodes may be comprised of a conductor which is operably connected to electronics located in the waterproof frame of the device. These electrodes provide the path for a signal to transmit from the outside of the device while maintaining needed functionality of preventing environmental contamination from entering the device. These electrodes may be composed of polymer, metal, composite, ceramic, or any other material provided the material can conduct at least trace amounts of electricity. These electrodes may have an electric potential or may be sensitive to electric potential in the environment to control the actuation of the device.

In a separate embodiment, a pressure-sensing switch is used to provide feedback to the controller of when the device reaches a certain depth in the water upon which power is supplied to the motor. Depending on the embodiment, the sensor may sense pressure greater than 101 kPa, such as greater than 105 kPa, greater than 110 kPa, greater than 120 kPa, greater than 140 kPa, greater than 160, greater than 180 kPa, greater than 200 kPa, greater than 220 kPa, greater than 240 kPa, greater than 260 kPa, greater 280 kPa, greater than 300 kPa, greater 320 kPa, greater than 340 kPa, greater than 360 kPa, greater than 380 kPa, greater than 400 kPa, greater than 450 kPa, greater than 500 kPa, greater than 550 kPa, greater than 600 kPa, greater than 700 kPa, greater than 800 kPa, greater than 900 kPa, or greater 1000 kPa in order to detect the change in pressure due to submersion in water of any depth. Combinations of the above pressure ranges are contemplated, including, for example, pressures between 101 kPa and 105 kPa, 102 kPa and 110 kPa, 109 kPa and 150 kPa, 149 kPa and 200 kPa, 199 kPa and 300 kPa, 299 kPA and 500 kPa, 499 kPa and 750 kPa, 749 kPa and 1000 kPa, or greater than 1000 kPa.

In a separate embodiment, a wireless communication link is established between the device and a remote control comprising a controller whose sole function is to actuate the device or with a computer such as a smartphone or tablet. Depending on the embodiment, the communication between the controller and the device may be made via an radiofrequency (RF) link, or a wireless communication protocol such as wifi, near field communication, or bluetooth. The range of the link may be as short as 1 inch, 2 inches, 4 inches, 8 inches, 16 inches, 1 meter, 2 meters, 4 meters, 8 meters, 16 meters, 24 meters, or as long as 32 meters. A user could control one or more devices using a single controller or one controller could be used to control one device.

In some embodiments, a device includes features to help prevent damage when used in corrosive environments such as those found when sportfishing in the ocean. Therefore, in one such embodiment, an optional waterproof enclosure and other waterproofing features may be used to protect the internals of a device from water, salt water, humidity, dust, and other environmental contaminants. This optional waterproof enclosure may be substantially flexible enough to allow for the motion of the device to be translated to the tail end of a bait fish but rigid enough to not absorb excessive energy that could otherwise be used to generate motion in the bait fish. In one embodiment, it may be desirable to retrieve and reuse a device even if it is no longer substantially or fully enclosed within the bait. In a preferred embodiment a feature is added to allow for a separate fishing hook to be coupled to the device. In an alternative embodiment, the device has an integrated hook as part of the device. In either embodiment, the device becomes coupled to the hook that is attached to the fishing line and can be reeled up by the user. The hook can be attached through a feature in the device comprised of a ridge, hole, hook, or other structure to which fishing line, steel braid, or other flexible connection can be made between the device and the user's fishing line. Additionally, this feature may accept a metal clip, leader, swivel, or any other fishing tackle to be operably connected. This feature may be added to any section of the embodiment for usability and strength. The feature used to connect the fishing line to may be made of any metal, plastic, composite, or other material and may or may not be reinforced with another material to expand its strength. This feature may be stationary or may pivot around one or more axes.

In the above embodiments, a device for use primarily in dead bait has been described. However, the currently disclosed devices are not limited to use only in dead bait. For example, in some embodiments, the disclosed devices may be disposed in a synthetic bait which may mimic the size and shape of similar live bait. Therefore, a device may be inserted into the synthetic bait to produce a desired type of motion in a manner similar to that described previously for dead bait.

Turning now to the figures several non-limiting embodiments are described in more detail. However, it should be understood that the current disclosure is not limited to only these embodiments, and that the various components, features, and methods of use described in relation to the figures may either be used individually or in any appropriate combination as the current disclosure is not so limited.

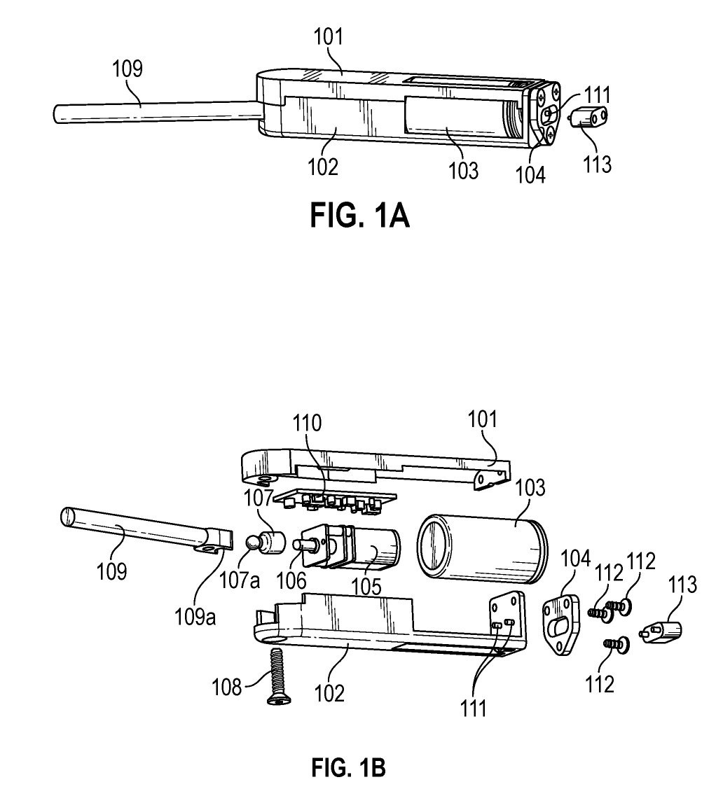

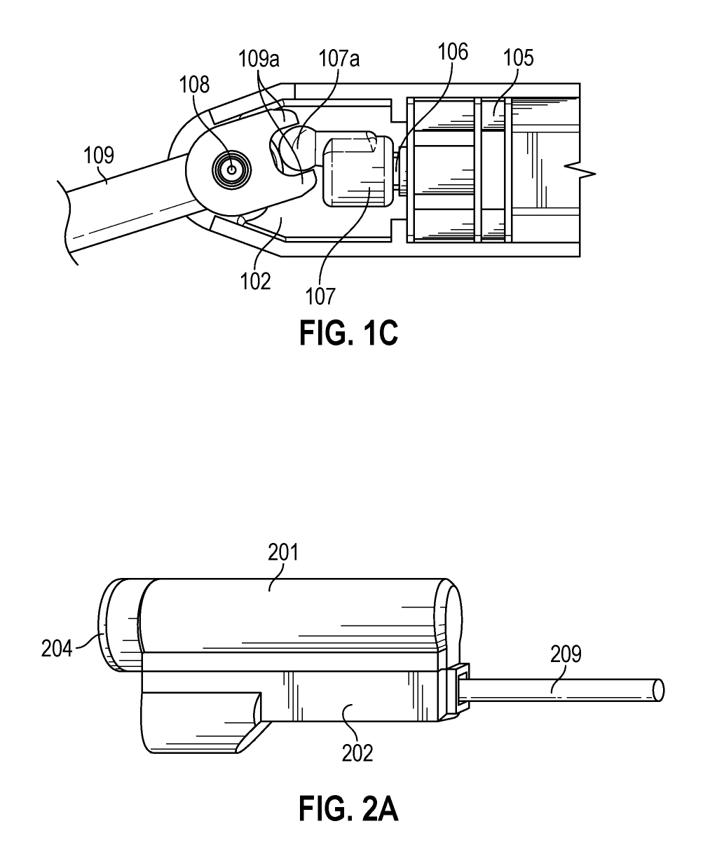

FIGS. 1(a)-1(c) depict one embodiment of a device for generating motion in bait. In the depicted embodiment, DC gearmotor 105 with a 100:1 drive ratio is mounted in lower housing 102 and is operably connected to shaft 106, which provides rotation to drive an eccentric crank 107. The orientation of the motor shaft 106 is parallel to the lengthwise axis of the device. Protruding from the crank 107 is an eccentric ball 107a which slides in a vertical slot in yoke 109a on pivoting movable portion 109. Movable portion 109 is mounted between upper housing 101 and lower housing 102 via pivot screw 108, which acts as a bearing. As the crank 107 spins, movable portion yoke 109a is driven side-to-side by eccentric ball 107a, pivoting about pivot pin 108. This creates a sinusoidal, periodic angular displacement of the movable portion 109. The magnitude of the displacement is determined by the amount of eccentricity of the ball 107a and distance between pivot pin 108 and the sliding surfaces of the movable portion yoke 109a, and in this example the displacement is about 15 degrees to either side. The movable portion 109 is substantially a cylinder 5 mm in diameter and 60 mm in length with a round end on one side and the movable portion yoke 109a at the other end. The movable portion 109 has a shape that facilitates ease of insertion into the end of a bait fish.

The power source for the motor in the depicted embodiment is comprised of one type RCR-123 3.7V nominal lithium ion secondary cell battery 103, which supplies direct current to the gearmotor 105. The gearmotor 105 is actuated by an electronic microcontroller and other electronic components on printed circuit board 110, which is able to sense its submersion into water or any other conductive environment by sourcing a current through two electrodes 111, which are exposed to the environment. When the contact 111 circuit is closed, the microcontroller sends a signal to the power electronics that turn on the device. The device is capable of varying its duty cycle, that is the amount of time that the device actuates its movable portion when submerged in water to allow for a user-selected motion of a continuous motion or an intermittent motion. In some embodiments, these two electrodes may be used to supply current back to the battery when attached to a charging circuit through plug 113, ensuring reusability of the device.

As illustrated in the figures, the device may include a housing with an upper housing 101 and lower housing 102, which is used to integrate and operationally connect the aforementioned components. The housing may be made of plastic, metal, or any other appropriate material. The upper housing 101 and lower housing 102 are configured to accommodate the battery directly behind the drive which helps to reduce the overall height of the device and further reduce the device's cross sectional area and volume. Upper housing 101 and lower housing 102 are assembled and fastened to one another with a chemical plastic weld, an ultrasonic weld, adhesives, threaded fasteners, mechanically interlocking features, or any other appropriate fastening method. Not shown in FIG. 1 is a rubber enclosure into which the entire device is inserted into prior to use to prevent ingress of environmental contaminants. This rubber enclosure has a snug-fit profile to the upper housing 101, lower housing 102, and movable portion 109. At the rear end of the rubber enclosure are the contacts 111, which are sealed against the lower housing 102 by endcap 104 and fastened by end cap screws 112.

Also shown in the figures, in some embodiments, a device includes a plurality of light emitting diodes, which provide visual feedback to the user about the charge status of the battery through various combinations and display patterns.

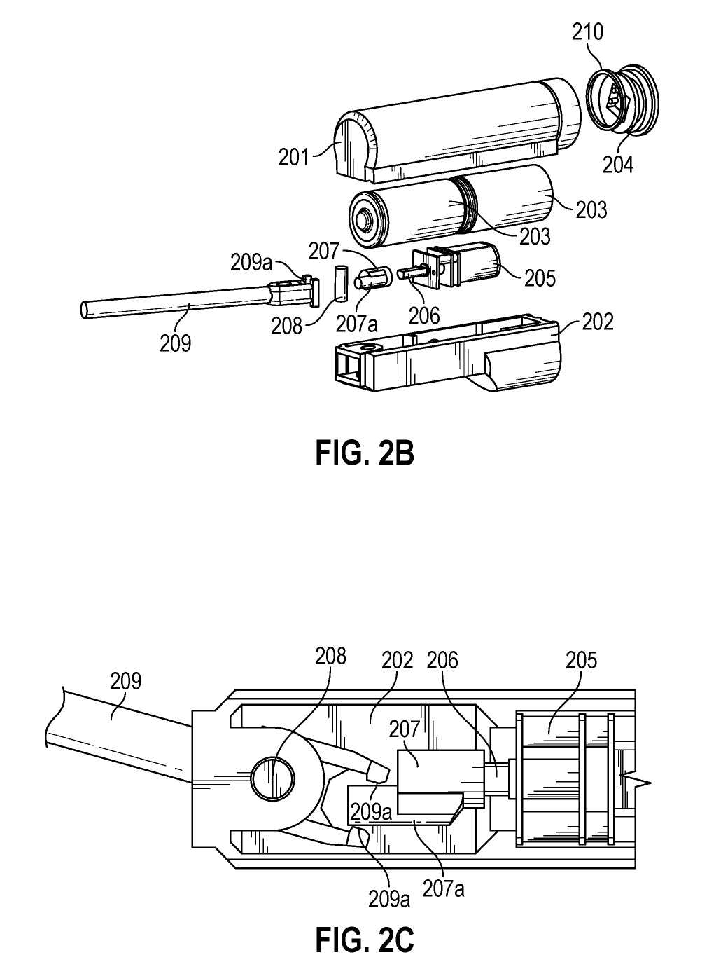

FIGS. 2(a)-2(c) describe another embodiment of a device. In the depicted embodiment, the device includes a housing including upper housing 201 and lower housing 202 used to contain and operationally connect the device components. This and other subcomponents may be 3D printed out of PLA plastic, though instances were molded, machined, or otherwise manufactured parts are used are also contemplated. The housing includes two sections, upper housing 201 and lower housing 202, to allow for ease of assembly and is then bonded together with a chemical plastic weld, though as noted previously, other attachment methods may be used.

The power source for the motor depicted in the figures is comprised of two type CR123a 3.7V lithium ion primary cell batteries 203 in series providing approximately 7.4V nominal direct current to the motor. The batteries 203 are connected together in series directly in the top half of the housing to reduce the overall cross sectional area and volume of the device. The batteries may be inserted and removed via battery door 204, which is sealed to upper housing 201 via a radial press fit of o-ring 210.

DC gearmotor 205 with a 100:1 drive ratio is mounted in lower housing 202 and is operably connected to shaft 206, which provides rotation to drive an eccentric crank 207. The orientation of the motor shaft 206 is parallel to the lengthwise axis of the device. Protruding from the crank 207 is an eccentric pin 207a which slides in a vertical slot in yoke 209a on pivoting movable portion 209. Movable portion 209 is mounted in lower housing 202 via pivot pin 208, which acts as a bearing. As the crank 207 spins, movable portion yoke 209a is driven side-to-side by eccentric pin 207a, pivoting about pivot pin 208. Because the rotational axis of the crank pin 207a and the pivot axis of movable portion 209 are perpendicular, a clearance is present between crank pin 207a and the walls of the vertical slot in yoke 209a to allow for the angular difference as movable portion 209 oscillates. The rotation of crank 207 thus creates a sinusoidal, periodic angular displacement of the movable portion 209. The magnitude of the displacement is determined by the amount of eccentricity of the ball 207a and distance between pivot pin 208 and the sliding surfaces of the movable portion yoke 209a, and in this example the displacement is about 15 degrees to either side. The movable portion 209 is substantially a cylinder 5 mm in diameter and 60 mm in length with a round end on one side and the movable portion yoke 209a at the other end. The movable portion 209 has a shape that facilitates ease of insertion into the end of a bait fish.

While not depicted in the figures, in some embodiments, a mechanical spring-loaded pushbutton switch may be used to turn the device on or off and may be mounted on the upper housing 201 and/or lower housing 202. In embodiments where a sealed enclosure is not used, the depicted device may be inserted into a flexible enclosure such as a plastic bag or enclosure with the movable portion. In some instances the flexible enclosure may include a portion for inserting the movable portion of the device into. Once positioned within the flexible enclosure, an opening of the flexible enclosure is tied off, or otherwise sealed, after removing air from within the enclosure. This may help to prevent environmental contaminants and moisture from reaching the electrical components and connections of the device while still allowing the required movement of movable portion 209 to be directly translated into the movement of the bait fish. In embodiments where a separate flexible enclosure is used, a pushbutton or other activation mechanism may still be easily actuated when the device is located within the enclosure.

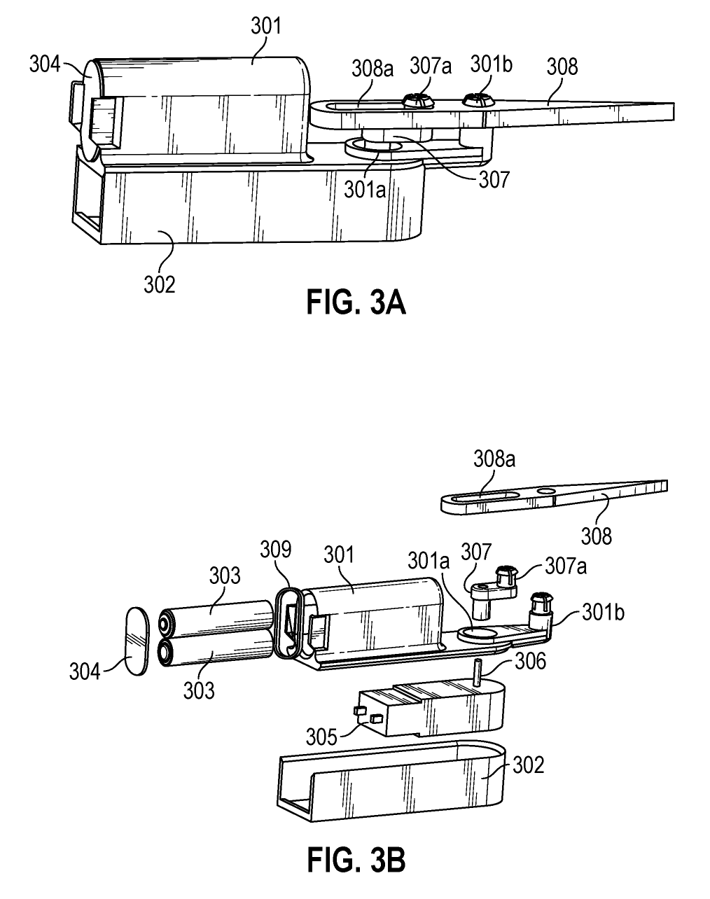

FIGS. 3(a) and 3(b) depict yet another embodiment of a device. The depicted device includes a housing with an upper housing 301 and lower housing 302 used to contain and operationally connect the device components batteries 303, gearmotor 305, output shaft 306, crank 307 and crank pin 307a, and battery door 304. The housing is comprised of two sections, upper housing 301 and lower housing 302 to allow for ease of assembly and is then bonded together with a chemical plastic weld or other appropriate attachment method.

The power source for the motor in this embodiment is comprised of two type AAA 1.5V alkaline primary cell batteries 303 in series providing 3V direct current to power gearmotor 305. The upper housing 301 stacks the two batteries on top of each other in the top half of the device to reduce overall width, which also facilitates ease of insertion into a bait fish. The upper housing 301 includes a battery door 304 which can be removed in order to facilitate changing the batteries 303. The battery door 304 is associated with rubber o-ring 309 located between the door and opening which ensures a seal of the battery door 304 opening when closed and affixed to upper housing 301. The battery door 301 may also contain conductive connections for coupling the two batteries in a series connection, not illustrated.

DC gearmotor 305 with a 100:1 drive ratio is mounted in lower housing 302 and is operably connected to output shaft 306, which provides rotation to drive an eccentric crank 307. The plastic geartrain of gearmotor 305 is oriented such that the output shaft 306 is perpendicular to the lengthwise axis of the device. A rubber U-cup may be used to create a dynamic seal between shaft 306 and the upper housing opening 301a. In this way, the electrical components of the device (the batteries, wiring, and gearmotor) are sealed inside the upper housing 301 and lower housing 302, while the crank 307 is exposed to the surrounding environment.

As shown in the figures, crank pin 307a may protrude up from crank 307. This crank pin 307a slides in a slot 308a located on a pivoting movable portion 308, which is mounted to the upper housing 301 via housing pin 301a, which acts as a bearing. As the crank pin 307a spins inside the movable portion slot 308a, movable portion 308 pivots about the housing pin 301b, creating a periodic, cycloidal, angular displacement of movable portion 308 from the center of the upper housing 301. The magnitude of the displacement is determined by the length of the crank 307 and distance between the housing pin 301b and movable portion slot 308a, with this displacement being approximately 15 degrees to either side in this example.

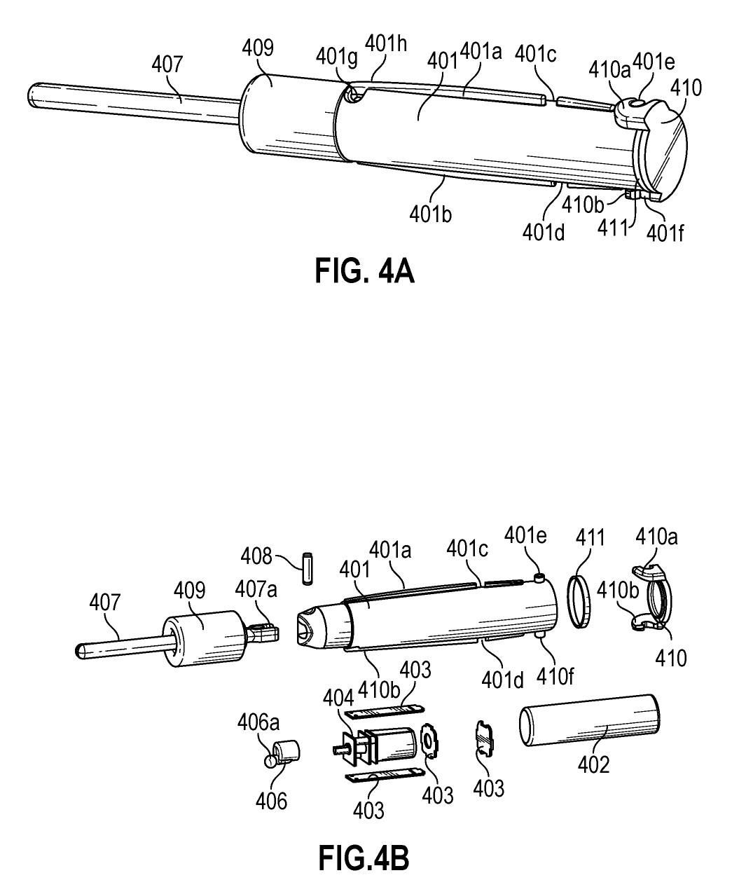

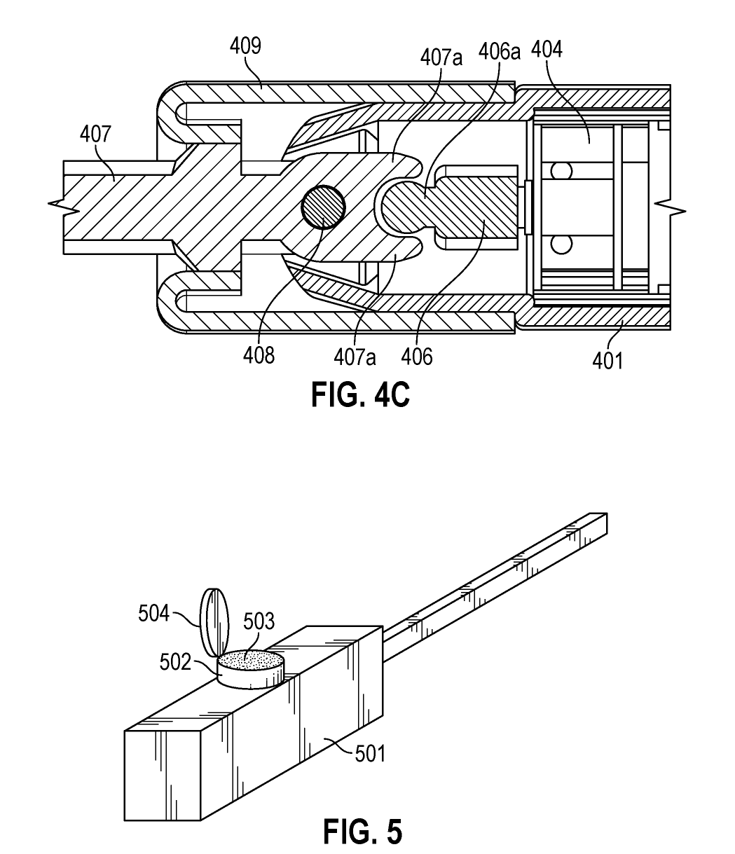

FIGS. 4(a)-4(c) illustrate yet another embodiment of the device. In the depicted embodiment, the device includes a housing 401 used to contain and operationally connect the device components. This and all structural subcomponents are made of injection molded plastic, though other methods of construction may also be used. To help stabilize a device within a bait, a device may include one or more ribs 401a and 401b prevent free rotation of the device inside the bait and maintain the preferred orientation of the device when inserted into a bait. The body of most bait fish is substantially oval in cross section, with the height (dorsal to pectoral) greater than the width. The ribs thus more easily occupy the height of the bait than the width, creating a bias towards a vertical orientation. This ensures the motion of the moving portion is side to side rather than up and down.

The device may also include one or more recesses 401c and 401d allow the user to tie a tether to the body of the device to aid in recovery during use. The power source for the motor in this example is comprised of a 3.7 volt DC rechargeable lithium ion secondary cell battery, 402. A printed circuit board (PCB) assembly 403 contains a plurality of operably connected PCBs which are attached to DC gearmotor 404. PCB assembly 403 contain the electronics required to generate 12V DC from battery 402 for powering the motor and also includes the sensing electronics for the device to turn on or off when placed in water. The PCB assembly is fully sealed with conformal coatings to prevent damage which may be caused by environmental contaminants. This PCB assembly also contains battery contacts located on the rearmost PCB.

DC gearmotor 404 has a 100:1 drive ratio is mounted in the housing 401 and is operably connected to shaft 404, which provides rotation to drive an eccentric crank 405. The orientation of the motor shaft 406 is parallel to the lengthwise axis of the device. Similar to the embodiment described above relative to FIGS. 1(a)-1(c), protruding from the crank 406 is an eccentric ball 406a which slides in yoke 407a on pivoting movable portion 407. movable portion 407 is mounted to housing 401 via pivot pin 408, which acts as a bearing. As the crank 406 spins, movable portion yoke 407a is driven side-to-side by eccentric ball 406a, pivoting about pivot pin 408. This creates a sinusoidal, periodic angular displacement of the movable portion 407. The magnitude of the displacement is determined by the amount of eccentricity of the ball 406a and distance between pivot pin 408 and the sliding surfaces of the movable portion yoke 407a, and in this example the displacement is about 15 degrees to either side.

The depicted embodiment may also include a bellow 409 that is operably connected to and creates a seal between housing 401 and movable portion 407 to prevent environmental contaminants and moisture from reaching the electrical components and connections while still allowing the required movement of movable portion 407 to be directly translated into the movement of the bait fish. The bellow is adhered at one end to the movable portion, and at the other end to the housing. The bellow is made of a soft, elastomeric material and also includes waves in its cross section, which allows compliance to the deflection imposed by the movable portion.

In some embodiments, it may be desirable to facilitate the removal and installation of one or more batteries 402 using a battery door 410. In the depicted embodiment, bayonet hooks 410a and 410b may engage housing pins 401e and 401f when a counter-rotation is applied by the user, securing the battery door 410 to housing 401 and also compressing an o-ring 411 to create a waterproof seal. Removal of battery door 410 is accomplished by the opposite motion. Electrically conductive epoxy may be applied to holes 401g and 401h, which makes an electrical connection with PCB assembly 403, enabling water sensing for activation of the device.

Example 5 describes the use of the devices described in examples 1, 2, 3, and 4 wherein the device is inserted into a bait fish. Example 4 shows two different possibilities of insertion. The first example described allows for the device to be inserted into a hole cut into the bait fish by the user which later can be closed by suturing or other means. The second example described allows for the device to be directly inserted into the open mouth of a dead bait fish by the user. The device can be oriented with the movable portion either facing the head of the fish or the tail of the fish, as either orientation will produce a differential angle of the tail with respect to the head, simulating the movement of a live bait fish. With the fish disposed of in a bait fish, the device can be actuated by either human interaction, i.e. actuation of a switch, or by insertion of the fish into water. Example 4 describes the device implanted into the bait fish in addition to a hook which can either be or not be mechanically connected to the device. The coupling of the fishing line to the device ensures a greater chance of recoverability after the device is removed from the water by reeling in the bait fish.

Depending on the application, it may be desirable to provide communication between a device and a remotely located control that may be used to control operation of the device. Functionality such as inducing vibration, emitting light, emitting sound, emitting scent, attractive coloration or decoration in the case of use with artificial bait, or other means of increasing attractiveness to predatory fish may be included in the device.

The device included with one or more off-balanced loads affixed to one or more motors could be included in the embodiment such that, when actuated, the device would vibrate in the water creating a perturbation in the surrounding water used to attract predatory fish. This vibration could be created continuously or at duty cycles similar to those for the actuation of the deflectable structure.

The device included with one or more light sources such as a light emitting diode contained in the embodiment such that the device would emit light to attract predatory fish. These light sources may illuminate continuously or at any interval or period. These light sources could be controlled by an electronic controller or timer.

In some embodiments, it may be desirable for a device to contain and discharge a chemical attractant over time. For example, such a device may be of benefit when using a synthetic bait, though such a feature may be used regardless of what type of bait the device is disposed within.

The device containing a chemical attractant would be discharged through a hole or vent located on the outside of the device or through a permeable membrane located with the waterproof enclosure. Of course it should be understood that any appropriate type of attractant may be used depending on the particular fish being targeted. For example, appropriate attractants include, but are not limited to, oils, liquid scents, flavored liquids, salts, water soluble chemicals as well as formulations of any of the above.

The device included with or imbued with a chemical attractant such that the attractant is dispersed into the water when submerged used to attract predatory fish to the device. The plastic material by which the device's outer components are made may be impregnated with chemical attractant which diffuses into the surrounding environment over a period of time. Additionally, as illustrated in FIG. 5, the device may have a reservoir 502 attached to a main housing 501, into which a chemical attractant 503 may be placed by the user, with a cap 504 having a filter or selectively permeable membrane to diffuse the attractant.

The device decorated with or painted in colors such that when not disposed of inside of a bait can be used to attract a predatory fish using its color, reflective coating, and its motion when actuated. The colors could be a paint or coating that reacts with water to change color over time or in response to an environmental parameter such as water temperature or salinity.

1. A motion-generating apparatus comprising:
a drive operably connected to a deflectable structure that is constructed and arranged to be inserted into a mouth of a bait fish, and wherein the drive and deflectable structure is capable of causing a deflection of a portion of the bait fish of at least 5 degrees.

2. The apparatus of claim 1, wherein the apparatus is operably connected to a fishing line.

3. The apparatus of claim 1, wherein the apparatus comprises a fishing line retention means.

4. The apparatus of claim 1, wherein the drive comprises a power source.

5. The apparatus of claim 1, wherein the bait fish is not capable of volitional movement, and wherein the apparatus is capable of simulating a swimming movement of the bait fish.

6. The apparatus of claim 1, wherein the apparatus does not contain a hook.

7. The apparatus of claim 1, wherein at least a portion of the apparatus is substantially water-resistant.

8. The apparatus of claim 4, wherein at least the power source is present in a substantially water-resistant material.

9. A fishing system comprising the apparatus of claim 1 and a bait fish.

10. A fishing system comprising the apparatus of claim 9 and a synthetic bait fish.

11. The apparatus of claim 1, further comprising a memory chip, controller, or other computational means.

12. The apparatus of claim 1, further comprising a means for generating sound.

13. The apparatus of claim 1, further comprising a means for release of a chemical attractant into an environment.

14. The apparatus of claim 1, further comprising a moisture-sensing switch.

15. The apparatus of claim 4 wherein the power source comprises an energy storage component selected from a battery and a capacitor.

16. The apparatus of claim 1, wherein the bait fish is selected from herring, mackerel and a fish of approximate size of a herring or a mackerel.

17. The fishing system of claim 9, wherein the system is capable of attracting a target fish selected from a tuna, a swordfish, and a king mackerel.

18. The fishing system of claim 9, comprising a motion simulation means configured to mechanically generate a first movement in a first direction along a first plane.

19. The fishing system of claim 9, comprising a motion simulation means configured to mechanically generate a first movement to simulate movement of a live bait fish.

20. The fishing system of claim 9, wherein the motion-generating apparatus is entirely disposed within the bait fish.

21. A method of producing a bait fish system, comprising:
inserting the motion-generating apparatus of claim 1 into and substantially through the mouth of a bait fish.

22. A device comprising:
a housing;
a moveable portion;
a drive that moves the movable portion relative to the housing, wherein the housing, movable portion, and drive are sized and shaped to fit at least partially within a bait fish, and wherein the drive and moveable portion when positioned in the bait fish move a first portion of the bait fish relative to a second portion of the bait fish.

23. A method comprising:
inserting a device including a housing and a moveable portion at least partially inside a bait fish;
moving the moveable portion relative to the housing to move a first portion of the bait relative to a second portion of the bait fish.
